(19) United States
(12) Patent Application Publication
(10) Pub. No.: US 2008/0038471 A1
(43) Pub. Date: Feb. 14, 2008

(54) Coating Method

(75) Inventors: Snjezana Boger, Esslingen (DE); Peter Englert, Bad Friedrichshall (DE); Frank Holzmann, Geislingen (DE); Matthias Pfitzer, Aalen (DE); Ingo Trautwein, Bietigheim-Bissingen (DE)

Correspondence Address: FOLEY AND LARDNER LLP;SUITE 500, 3000 K STREET NW, WASHINGTON, DC, 20007, US

(73) Assignee: BEHR GmbH & Co. KG, Stuttgart (DE)

(21) Appl. No.: 11/576,918

(22) PCT Filed: Oct. 5, 2005
(86) PCT No.: PCT/EP05/10800

§ 371 Date: May 31, 2007

(30) Foreign Application Priority Data
Oct. 7, 2004 (DE) 10 2004 049 107.0

(51) Int. Cl. B05D 3/02; B05C 11/02

(52) U.S. Cl. 427/374.1; 118/69

(57) ABSTRACT

The invention relates to a method for coating heated work pieces.

The present invention relates to a method for coating workpieces made from metal and/or one or more alloys, to a workpiece which is manufactured by means of this method, and to an apparatus for coating workpieces.

The direct coating of aluminum or aluminum alloys by means of organic coating systems is almost impossible on account of the low adhesion capability of the organic coating systems on the aluminum. In order to improve the adhesion promotion between the initial material and organic coating systems, it is therefore known to subject aluminum or aluminum alloys to what is known as a bohmite treatment, hot water or hot steam, optionally together with ammonium or amines, being brought into combination with the workpiece, with the result that an aluminum oxide or bohmite layer is formed or thickened. This then makes application of an organic coating possible.

EP 1 142 663 A1 describes bohmite methods, in the context of which deionized water is used at temperatures of approximately 100° C. or steam is used at temperatures of 150° C., in order to modify the surface of aluminum parts.

A bohmite treatment of aluminum parts with water at a temperature of from 65 to 100° C. or steam at temperatures of from 100 to 180° C. is apparent from U.S. Pat. No. 3,945,899, the addition of amines and ammonium bringing about further thickening of the aluminum oxide layer. It is also known from this publication to subject aluminum or its alloys to a chemical surface treatment with the use of aqueous solutions of chromates or phosphates, in order to increase the adhesion capability in this way firstly and secondly to reduce the susceptibility to corrosion. This so-called conversion treatment is also known from Stolzenfels (Industrie-Lackierbetrieb [Industrial coating operation], no. 3, pages 93-98, Curt R. Vincentz Verlag), which document describes chromating treatments of the aluminum workpieces at temperatures of from 20 to 50° C. Riese-Meyer et al. (Aluminium 1991, no. 12, pages 1215-1221) describes chemical conversion treatments by means of layer-forming phosphating treatments and chromating treatments, as a result of which the paint adhesion and the corrosion protection of aluminum workpieces can be improved. According to this document, the chromating treatment is also carried out at a temperature of from 20 to 30° C. or from 30 to 40° C.

The abovementioned methods prove disadvantageous, however, inter alia on account of energy considerations. As the workpieces which are to be modified according to the prior art are usually at room temperature, that is to say are used in the cold state in comparison with the preceding soldering or joining process, the result is an increased handling and time requirement in the surface modification of workpieces of this type.

The present invention is based, in particular, on the technical problem of providing a method which overcomes the abovementioned disadvantages, in particular of providing a method which makes hydrophilic covering layers and/or covering layers with improved adhesion and/or reduced odor possible on workpiece surfaces.

A method according to the present invention serves to coat workpieces made from metal and/or one or more alloys, the workpieces preferably comprising aluminum, copper and/or magnesium or an alloy of one of the abovementioned metals. The method comprises provision of the workpiece, application of the coating raw material onto a surface of the workpiece, heating of the workpiece and cooling of the workpiece.

In conjunction with the present invention, a workpiece is understood as an object of any desired configuration which can be present, for example, as a shaped body, that is to say a body of defined design, but also as a granulate or powder. In one preferred embodiment, the workpiece is present as a heat exchanger or a substantial constituent part of the former.

The object of the invention is preferably achieved by the coating raw material being converted into at least one covering layer by a thermally activated process, which covering layer is particularly preferably formed continuously. In some circumstances, formation of a covering layer with desired properties is made possible in a simple way by simple heating of a suitably selected coating raw material and/or the workpiece.

A preferred thickness of the covering layer lies between 30 nm and 10 000 nm, in particular between 200 nm and 1000 nm. The thickness of the covering layer is particularly preferably between 400 nm and 700 nm. In another embodiment, the thickness of the covering layer is between 1000 nm and 4000 nm, preferably between 2000 nm and 3000 nm. In a further advantageous refinement, the thickness lies between 4500 nm and 8000 nm.

The workpiece is preferably heated before the application of the coating raw material. If the coating raw material is applied onto the heated workpiece, the thermally activated conversion can take place immediately and excess coating raw material can be washed away again and/or reused in some circumstances. It is also possible in one variant to heat the workpiece only after the application of the coating raw material.

According to one advantageous embodiment, the covering layer is of hydrophilic configuration, with the result that, for example, water which has condensed on the surface of the workpiece runs off the surface in an improved manner. As a result, in particular if the workpiece is used as a heat exchanger or in a heat exchanger, an impairment of the function of the heat exchanger is reduced or avoided.

According to one variant, the covering layer is of low-odor configuration. After application of the method according to the invention, the workpiece advantageously achieves a better grade than grade 3 (“can be discerned clearly, but not yet disruptive”) in an odor test according to VDA 270. The selection of the coating raw material for the formation of the covering layer is particularly advantageous, as a result of which coating raw material the workpiece achieves grade 2 (“can be discerned, but not disruptive”) or better.

According to one preferred refinement, the coating raw material is applied onto all or substantially all surfaces of the workpiece. This is brought about, for example, by dipping the workpiece into the coating raw material, flooding the workpiece with the coating raw material or spraying the workpiece with the coating raw material.

The workpiece is preferably heated to at least 400° C., in particular to at least 430° C., as a conversion of the coating raw material by thermal activation takes place in a short time at such temperatures.

According to preferred embodiments of the invention, the conversion of the coating raw material in order to form a covering layer takes place as a chemical reaction with the surface of the workpiece, as a chemical conversion, in particular polymerization of the coating raw material, as sintering of the coating raw material, as conversion, in particular ceramization of the coating raw material.

According to advantageous refinements, the coating raw material comprises one or more organic compounds, preferably in particular polymers, monomers and/or oligomers which are based on polyurethane or polyvinyl alcohol. In particular in this case, the surface of the workpiece is heated to from 40 to 350° C. For an effective conversion of the coating raw material, heating of the workpiece to from 80 to 300° C. is advantageous in some circumstances, it being possible for particularly good results to be achieved with heating of the workpiece to from 150 to 250° C.

The coating raw material advantageously comprises additional particles having a preferred diameter between 1 and 100 nm, at which the additional particles have special properties. A diameter between 1000 and 10 000 nm in other variants is likewise advantageous in some circumstances. In some exemplary embodiments, a diameter in the intermediate range between 100 and 1000 nm is also advantageous.

In other variants, the additional particles comprise TiO₂, SiO₂, ZrO₂, Al₂O₃ or cations of transition group metals, in particular Zr, Ti, V, Mn, or of main group elements, in particular Al, Si. As a result of this, desired properties of the covering layer are reinforced in some circumstances.

According to advantageous refinements, the coating raw material comprises one or more inorganic compounds, preferably metallic and/or non-metallic salts, in particular NaSiO₃, KSiO₃, NH₄OH, KOH, NaOH, and/or water, in particular fully demineralized or distilled water. In particular in this case, the surface of the workpiece is heated to from 80 to 900° C. For an effective conversion of the coating raw material, heating of the workpiece to from 200 to 700° C. is advantageous in some circumstances, it being possible for particularly good results to be achieved with heating of the workpiece to from 350 to 550° C. In one embodiment, heating of the workpiece to a temperature between 400° C. and 500° C. is advantageous, in particular, for the manufacture of a continuous layer.

According to one preferred embodiment, at least one covering layer inhibits or prevents germ formation on the surface of the workpiece. As a result, an undesirable odor is avoided in some circumstances.

According to one advantageous refinement, the temperature of the coating raw material is at least −200° C., in particular at least 0° C., and at most 100° C., in particular at most 80° C., during the application onto the surface of the workpiece. In one embodiment, the temperature between 90° C. and 100° C. has been proven for the coating raw material. The method is particularly simple if no temperature control of the coating raw material is necessary, that is to say if the coating raw material is applied onto the workpiece at room temperature.

According to one variant, the temperature of the coating raw material is between 80 and 550° C. during the application onto the surface of the workpiece. A small temperature difference between the coating raw material and the surface of the workpiece is advantageous here; the coating raw material and the surface of the workpiece are particularly advantageously at substantially the same temperature during the application.

In one preferred embodiment of the present invention, the workpiece is constructed from aluminum, magnesium, copper or one or more aluminum and/or magnesium and/or copper alloys, that is to say it comprises aluminum or one or more alloys or comprises aluminum or one or more aluminum alloys substantially, for example in proportions of at least 50, 60, 70, 80, 90, 95 and, in particular, 99% by weight, in relation to the weight of the workpiece.

In one preferred embodiment, the heating of the workpiece is achieved in that the workpiece is subjected to a method according to the invention in the still hot form directly after its manufacturing process, for example after exiting the soldering zone, after thermal joining processes, or after heating in batch furnaces, with utilization of existing thermal capacity of the workpiece.

In one advantageous embodiment, there is provision for the workpiece which already has a CAB-flux layer on account of a preceding CAB soldering process to be treated by the procedure according to the invention in such a way that the existing CAB-flux layer is modified in a chemical-physical manner. The procedure according to the invention can result in doping of the existing flux layer, for example with metals of the main groups I, II, III or IV or the transition groups, in particular IV to VI, and/or in an increase in the oxygen proportion. The treatment according to the invention then results in improved corrosion resistance in some circumstances.

The treatment, which is preferably provided according to the invention, of (CAB)-flux coated workpieces leads in some circumstances to an advantageous scaly, closed and rounded appearance of the flux layer of the workpieces which differs from the open pore, angular and platelet-like appearance of untreated flux coated workpieces.

After the coating, the workpiece can be treated further in a conventional manner, in particular rinsed and dried. It goes without saying that a further coating can also take place, for example by means of organic coating systems. In some circumstances, the present method therefore represents one part of the manufacturing process of a workpiece, for example of a heat exchanger. In the context of this manufacturing process, the method of manufacturing which is provided according to the invention leads to a reduction in the manufacturing costs for workpieces, to the saving of energy and resources, in particular by the use of present thermal capacities of the workpieces, and to the reduced use or to the avoidance of the use of aggressive chemicals for surface treatment.

In some circumstances, all known chemical elements, compounds, mixtures or other compositions may be suitable as coating raw material. The coating raw material which is preferably used is one or more compounds, in particular one or more metal salts of one or more elements of the transition groups of the Periodic Table of Elements, in particular of the transition groups IV to VI of the Periodic Table of Elements, for example titanium, hafnium, vanadium, tantalum, molybdenum, tungsten and, in particular, zirconium.

In a further embodiment of the present invention, the coating raw material can be one or more compounds, in particular one or more metal salts of one or more elements of the main groups I, II, III and/or IV of the Periodic Table of Elements, for example a metal salt of beryllium, barium, in particular of magnesium of calcium or sodium or potassium.

In a further embodiment of the present invention, the coating raw material can be one or more compounds of one or more elements of the main groups V, VI, VII and/or VIII of the Periodic Table of Elements.

In one preferred embodiment of the invention, the abovementioned metals can be present in salt form with anions selected from the group which comprises chlorides, carbonates, in particular hydrogencarbonates, nitrates, sulfates, peroxides and phosphates. In particular, the metal salts of the elements of the main groups I and II, for example potassium, sodium and calcium, can be present as a leachate, that is to say KOH, NaOH or Ca(OH)₂, or as a borate, aluminate, silicate or halide, in particular fluoride.

In a further preferred embodiment of the invention, at least one coating raw material is a CAB-flux (“controlled atmosphere brazing”) of the general formula KₓAlF_{y}, where x is from 1 to 3 and y equals from 4 to 6, for example potassium aluminum hexafluoride and/or CsₓAlF_{y}.

In a further preferred embodiment, an ammonium salt, such as ammonium fluoride or ammonium carbonate, potassium fluoride, sodium or potassium silicate, sodium or potassium chlorate, sodium or potassium aluminate, crosslinkable, in particular organometallic compounds, such as organozirconium, organotitanium or organosilicon compounds, or else hydrogen peroxide is used as coating raw material.

In one particularly preferred embodiment, the CAB-flux, ammonium salt and/or potassium fluoride are/is used for the treatment of the workpiece in the form of aqueous, preferably alkaline, solutions or alkaline steams or aerosols.

The metal compounds of one of the elements of the transition groups, in particular transition groups IV to VI, or of the main group I, II, III or IV, can be present in an organic and/or inorganic phase, preferably in an aqueous phase, in particular in a liquid or gaseous phase, preferably in aerosol form or as steam. The water which is used for the solution is preferably fully demineralized water.

In a further preferred embodiment, there is provision for water, preferably fully demineralized and distilled water to be used as coating raw material for treating the surface of the workpiece, which reacts chemically, for example, with the surface of the workpiece in order to form the covering layer. It goes without saying that it is also possible according to the invention to use aqueous solutions of ammonia, of amines, in particular primary, secondary or tertiary amines, for example monoethanolamines, diethanolamines or triethanolamines, dimethylethanolamines, organic acids or salts or salts of ammonia, amines, halogenated organic compounds and/or inorganic acids as surface-modifying medium. It goes without saying that mixtures of the abovementioned surface-modifying media can also be used.

A solution of 0.1-1% KOH and/or 0.1-1% NH₄OH and/or 0.1-1% KₓAlF_{y} (x=1 to 3, y=4 to 6) and/or 0.1-1% Ca(NO₃)₂ and/or 0.1-1% salts of the elements of the transition groups IV to VI of the Periodic Table of Elements in fully demineralized water is preferably used.

In one particularly preferred embodiment of the present invention, a CAB-flux coated workpiece which results from a CAB soldering process is used as initial workpiece for the method according to the invention, which workpiece is treated under the specified conditions with one or more of the coating raw materials used. Here, in particular in the case of treatment of the surface with water or aqueous solutions, the covering layer with an increased oxygen proportion can be obtained, it also being possible for the latter to be doped depending on the type of modifying medium used, for example with one or more of the metals of the main group I, II, III or IV or the transition groups, in particular the transition groups IV to VI, or other coating raw materials.

In another preferred embodiment, the invention provides for the metal salt, the CAB-flux, ammonium salt and/or potassium fluoride or another constituent part of the coating raw material to be used in a matrix, for example a matrix comprising organic and/or inorganic solvents or mixtures thereof, in order to treat the surface of the workpiece. Here, the matrix comprises organometallic, in particular organosilicon compounds. In particular, the matrix comprises organic and/or inorganic polymers, or else a mixture of the abovementioned materials.

In one particularly preferred embodiment, there is provision for the metal salt, the CAB-flux, ammonium fluoride and/or potassium fluoride or another constituent part of the coating raw material to be used in the treatment in a concentration of from 10 ppm to 100 000 ppm, preferably of from 50 ppm to 10 000 ppm.

The at least one coating raw material is preferably brought into contact with the workpiece by the workpiece being dipped into the at least one coating raw material and impregnated, or by it being rinsed or flooded with the at least one coating raw material and impregnated in the process, or by the at least one coating raw material being sprayed onto the workpiece, in particular by means of what is known as airless or ultrasonic atomization, or by being brought into contact in some other way.

In one particular embodiment, there can be provision for the coating raw material to be allowed to act on the workpiece under pressure which is increased in comparison with atmospheric pressure. In this spraying process, another gas, for example oxygen, nitrogen, fluorine, ozone or steam, can also be used in addition to compressed air.

For example, aqueous solutions of Ca(NO₃)₂ or Zr(NO₃)₄ can be used as metal salts, in particular at concentrations between 0.1% and 5%, their pH value preferably lying between 5.5 and 7.5 to 8. Here, the application temperature advantageously lies between 40° C. and 60° C. It is also advantageous in some circumstances to add from 0.005% to 5% tetraethyl ammonium tetrafluoroborate. In particular, a soldered, preferably CAB-soldered, heat exchanger is treated with a solution of this type.

According to one advantageous embodiment, the covering layer has a biocide. For example in a heat exchanger in a heating and/or air conditioning system, germ prevention which results from this is desired. For this purpose, in one preferred embodiment, the coating raw material comprises from 0.005% to 5%, in particular from 0.01% to 1%, particularly preferably from 0.05% to 0.5% sodium and/or potassium silicate, for example in, in particular, fully demineralized water. A coating raw material with silver particles is also advantageous, in particular in one of the concentrations which are specified above, the combination of a silicate with silver particles imparting particularly germ-inhibiting properties to the covering layer in some circumstances. Here, the silver particles preferably have a diameter of from 1 to 100 nm. As variants, silver particles having a diameter of from 100 to 500 nm or from 500 to 1000 nm are also advantageous.

It goes without saying that the invention also relates to workpieces which are manufactured by means of the abovementioned methods, in particular coated heat exchangers made from aluminum or aluminum alloys. The heat exchanger is particularly preferably an evaporator, in particular of a motor vehicle air conditioning system.

In one advantageous development of the invention, the workpiece is provided with one or more organic or inorganic coating systems in a further step, which coating systems particularly preferably have additional germ-inhibiting and/or hydrophilic or hydrophobic properties. The application of layers of this type which are similar to paint is possible both with and without a drying step in between.

The object of the invention is also achieved by an apparatus for coating workpieces having a temperature-controlled chamber and a device which is arranged in or on the temperature-controlled chamber for applying the coating raw material onto the workpieces.

The device for applying the coating raw material is preferably configured as a spray nozzle which can be particularly preferably temperature-controlled itself in order to carry out the method according to the invention. Temperature control of the coating raw material in a feed line of the device is equally possible.

Further advantageous refinements of the present invention result from the subclaims.

1. A method for coating workpieces made from metal and/or one or more alloys, comprising provision of a workpiece, application of the coating raw material onto a surface of the workpiece, heating of the workpiece, thermally activated conversion of the coating raw material to form at least one, in particular continuous, covering layer, and cooling of the workpiece.

2. The method as claimed in claim 1, wherein the workpiece comprises in particular mainly aluminum, copper and/or magnesium at least in the region which is close to the surface.

3. The method as claimed in claim 1, wherein the covering layer is continuous, hydrophilic and/or low-odor.

4. The method as claimed in claim 1, wherein the coating raw material is applied onto all or substantially all surfaces of the workpiece.

5. The method as claimed in claim 1, wherein the coating raw material is applied onto the surface of the workpiece by application, painting, dipping, flooding and/or spraying.

6. The method as claimed in claim 1, wherein the workpiece is heated to at least 400° C., in particular to at least 430° C.

7. The method as claimed in claim 1, wherein the coating raw material reacts chemically with the surface of the workpiece in order to form a covering layer.

8. The method as claimed in claim 1, wherein the coating raw material is converted chemically, in particular is polymerized, in order to form a covering layer.

9. The method as claimed in claim 1, wherein the coating raw material is sintered in order to form a covering layer.

10. The method as claimed in claim 1, wherein the coating raw material is converted, in particular is ceramized, in order to form a covering layer.

11. The method as claimed in claim 1, wherein the workpiece is heated after the application of the coating raw material.

12. The method as claimed in claim 1, wherein the coating raw material is applied onto a heated surface.

13. The method as claimed in claim 1, wherein the coating raw material comprises one or more organic compounds, preferably in particular polymers, monomers and/or oligomers which are based on polyurethane or polyvinyl alcohol, the surface of the workpiece being heated preferably to from 40 to 350° C., particularly preferably to from 80 to 300° C., in particular to from 150 to 250° C.

14. The method as claimed in claim 1, wherein the coating raw material comprises additional particles, the diameter of which lies, in particular, between 1 and 100 nm, between 100 and 1 000 nm or between 1 000 and 10 000 nm.

15. The method as claimed in claim 1, wherein the coating raw material has additional particles comprising TiO2, SiO2, ZrO2, A12O3 or cations of transition group metals, in particular Zr, Ti, V, Mn, or of main group elements, in particular Al, Si.

16. The method as claimed in claim 1, wherein the coating raw material comprises one or more inorganic compounds, preferably metallic and/or non-metallic salts, in particular NaSiO3, KSiO3, NH4OH, KOH, NaOH, and/or water, in particular fully demineralized or distilled water, the surface of the workpiece being heated preferably to from 80 to 900° C., particularly preferably to from 200 to 700° C., in particular to from 350 to 550° C., advantageously to from 400 to 500° C.

17. The method as claimed in claim 1, wherein at least one covering layer inhibits or prevents germ formation on the surface of the workpiece.

18. The method as claimed in claim 1, wherein at least one covering layer inhibits or prevents the formation of droplets, in particular of condensed water, on the surface of the workpiece, in particular imparts hydrophilic properties to the surface of the workpiece.

19. The method as claimed in claim 1, wherein the coating raw material has a temperature of at least −200° C., in particular at least 0° C., and at most 100° C., in particular at most 80° C., during the application onto the surface of the workpiece.

20. The method as claimed in claim 1, wherein the coating raw material has a temperature of from 80 to 550° C., preferably of from 80 to 200° C., particularly preferably of from 90 to 100° C., during the application onto the surface of the workpiece.

21. The method as claimed in claim 1, wherein the coating raw material has a salt, in particular a metal salt, in particular of an element of one of the transition groups, in particular of the transition groups IV to VI of the Periodic Table of Elements.

22. The method as claimed in claim 1, wherein the coating raw material is a metal salt of an element of the main group I, II, III or IV of the Periodic Table of Elements.

23. The method as claimed in claim 1, wherein the coating raw material has a compound of an element of the main group V, VI, VII or VIII of the Periodic Table of Elements.

24. The method as claimed in claim 1, wherein the coating raw material has a CAB-flux, in particular potassium aluminum hexafluoride.

25. The method as claimed in claim 1, wherein the coating raw material has an ammonium salt, in particular ammonium fluoride, potassium fluoride, sodium or potassium silicate, sodium or potassium borate, sodium or potassium aluminate and/or at least one crosslinkable compound, such as an organometallic, in particular organozirconium or organotitanium compound and/or at least one organosilicon compound or the like.

26. The method as claimed in claim 1, wherein the metal salt is present in an aqueous phase, its pH value lying in particular between 1 and 14, in particular between 3 and 10, in particular between 4 and 8.

27. The method as claimed in claim 1, wherein the CAB-flux, the ammonium salt or the potassium fluoride is present in a phase having an alkaline pH value.

28. The method as claimed in claim 1, wherein the coating raw material comprises water, in particular fully demineralized and distilled water, or an aqueous solution comprising ammonia, amines, gases or organic acids, or their salts or mixtures thereof.

29. The method as claimed in claim 1, wherein a salt, in particular a metal salt, a CAB-flux, ammonium fluoride, potassium fluoride, sodium or potassium silicate, sodium or potassium borate and/or sodium or potassium aluminate and/or at least one crosslinkable compound, such as an organometallic, in particular organozirconium or organosilicon compound or the like is/are used in a matrix for application onto the surface of the workpiece.

30. The method as claimed in claim 1, wherein the matrix is constructed from organic or inorganic solvents or mixtures thereof.

31. The method as claimed in claim 1, wherein a salt, in particular a metal salt, a CAB-flux, ammonium fluoride, potassium fluoride, sodium or potassium silicate, sodium or potassium borate and/or sodium or potassium aluminate and/or organometallic, in particular organozirconium or organosilicon compounds is/are used for application onto the surface of the workpiece in a concentration of from 10 ppm to 100 000 ppm, in particular of from 50 ppm to 10 000 ppm.

32. The method as claimed in claim 1, wherein the coating raw material has a biocide or a corrosion inhibitor, or generates a biocide or a corrosion inhibitor on the surface of the workpiece.

33. A workpiece, manufactured in accordance with the method as claimed in claim 1.

34. The method or workpiece as claimed in claim 1, wherein the workpiece is a heat exchanger, in particular an evaporator, or a constituent part of a heat exchanger or evaporator, in particular for motor vehicles.

35. An apparatus for coating workpieces, in particular for carrying out the method as claimed in claim 1, having a temperature-controlled chamber and a device which is arranged in or on the temperature-controlled chamber for applying a coating raw material onto the workpieces.

36. The apparatus as claimed in claim 1, in which the device for applying a coating raw material onto the workpieces is configured as at least one spray nozzle which can be, in particular, temperature-controlled.
